(19) United States
(12) Patent Application Publication
(10) Pub. No.: US 2011/0281210 A1
(43) Pub. Date: Nov. 17, 2011

(54) DEVELOPING AGENT

(75) Inventor: Tsutomu Katsumata, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/098,596

(22) Filed: May 2, 2011

Related U.S. Application Data
(60) Provisional application No. 61/333,371, filed on May 11, 2010.

(51) Int. Cl. G03G 9/08

(52) U.S. Cl. 430/108.4

(57) ABSTRACT

According to one embodiment, a developing agent includes a toner resin containing a coloring material, a binder resin, an ester wax and a crystalline polyester resin. The ester wax has an alkyl group with a carbon number of from 32 to 46, when an ion intensity ratio at each carbon number is expressed in terms of percentage, a content of an ester compound having a carbon number showing its maximum intensity ratio is from 20 to 55% by weight of the whole of the wax, and a content of ester compounds with a carbon number of not more than 38 is not more than 10% by weight of the whole of the wax. The ester wax has an endothermic peak measured by DSC of from 60 to 75° C. The crystalline polyester resin has an endothermic peak measured by DSC of from 90 to 110° C.

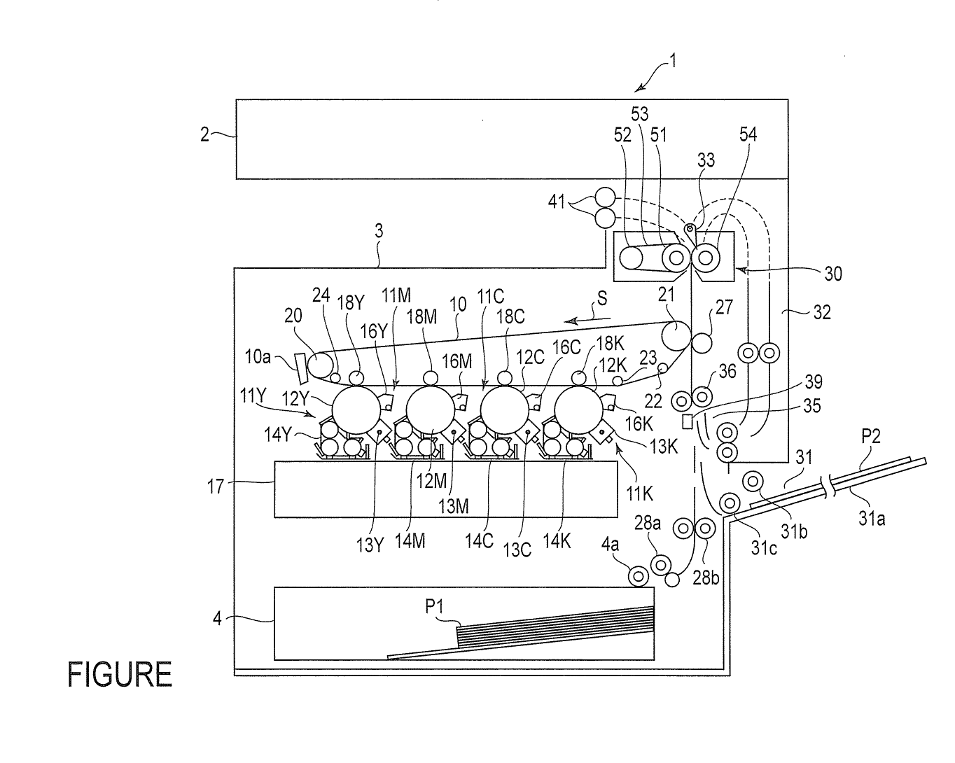

### CROSS-REFERENCE TO RELATED APPLICATIONS

This application is based upon and claims the benefit of priority from U.S. Provisional Application No. 61/333,371, filed on May 11, 2010; the entire contents of which are incorporated herein by reference.

### FIELD

Embodiments described herein relate generally to a developing agent for developing an electrostatic image or a magnetic latent image in, for example, an electrophotographic process, an electrostatic printing process and a magnetic recording process.

### BACKGROUND

As materials constituting a toner for forming a multicolor image, there are known an ester wax with excellent characteristics in fixability, especially resistance to high-temperature offset and a crystalline polyester resin with excellent characteristics in resistance to low-temperature offset.

For example, when an ester wax is used, in view of the fact that a straight chain of the ester wax is long, there is involved such a problem that the ester wax is poor in resistance to low-temperature offset. When the straight chain of the ester wax is shortened, a glass transition point (Tg) of the toner is decreased, and the low-temperature offset can be improved. Furthermore, when this ester wax is used in combination with a crystalline polyester resin with excellent resistance to low-temperature offset, the toner Tg is largely decreased, and the low-temperature offset can be greatly improved. However, when the toner Tg is largely decreased, there is involved such a problem that the toner aggregates when allowed to stand at a high temperature, whereby preservability is deteriorated, or there is a tendency that toner scattering is deteriorated with the progress of a life.

In consequence, according to the related-art toners, there is involved such a problem that it may be difficult to make low-temperature fixation and preservability and life extension compatible with each other.

### BRIEF DESCRIPTION OF THE DRAWINGS

FIGURE illustrates a diagrammatic view showing an example of an image forming apparatus to which a developing agent according to an exemplary embodiment is applicable.

### DETAILED DESCRIPTION

In general, according to one embodiment, there is provided a developing agent including a toner particle containing a coloring material, a binder resin, an ester wax and a crystalline polyester resin.

The ester wax which is used in an exemplary embodiment has an alkyl group with a carbon number of from 32 to 46. When an ion intensity ratio at each carbon number of this ester wax is expressed in terms of percentage, a content of the ester compound having a carbon number showing its maximum intensity ratio is from 20 to 55% by weight of the whole of the wax. Also, in this ester wax, a content of the ester compounds with a carbon number of not more than 38 is not more than 10% by weight of the whole of the wax. Furthermore, in this ester wax, an endothermic peak measured using a differential scanning colorimeter, so-called DSC is from 60 to 75° C.

Also, the crystalline polyester resin which is used in the exemplary embodiment has an endothermic peak measured by DSC of from 90 to 110° C.

The developing agent according to the exemplary embodiment is favorable in wax dispersibility in the toner. Also, by using the ester wax which does not deteriorate preservability when allowed to stand at a high temperature in combination with the crystalline polyester resin, it is possible for the developing agent to realize low-temperature fixation as compared with the related-art toners. In this way, when the developing agent according to the exemplary embodiment is used, low-temperature fixation, preservability and life extension become favorable.

As the binder resin, a polyester resin can be used.

The ester wax can be, for example, added in an amount of from 3 to 17 parts by weight based on 100 parts by weight of the binder resin.

As to the polyester resin component which is used in the exemplary embodiment as the binder resin, a dihydric or higher hydric alcohol component and a divalent or higher valent carboxylic acid component such as carboxylic acids, carboxylic acid anhydrides and carboxylic acid esters are used as raw material monomers of the polyester.

Examples of the dihydric alcohol component include alkylene oxide additives of bisphenol A, such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A and hydrogenated bisphenol A.

Furthermore, as the dihydric alcohol component, bisphenol A-alkylene (carbon number: 2 or 3) oxide adducts (average addition molar number: from 1 to 10), ethylene glycol, propylene glycol, 1,6-hexanediol, bisphenol A or hydrogenated bisphenol A can be selected.

Examples of the trihydric or higher hydric alcohol component include sorbitol, 1,2,3,6-hexanetetrole, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxymethylbenzene.

Furthermore, as the trihydric or higher hydric alcohol component, sorbitol, 1,4-sorbitan, pentaerythritol, glycerol or trimethylolpropane can be selected.

In the exemplary embodiment, these dihydric alcohols and trihydric or higher hydric alcohols can be used singly or in combination. It is especially preferable to use a bisphenol A-alkylene (carbon number: 2 or 3) oxide adduct (average addition molar number: from 1 to 10) as the major component.

Examples of the divalent carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkenylsuccinic acids such as n-dodecenylsuccinic acid, alkylsuccinic acids such as n-dodecylsuccinic acid, and acid anhydrides or lower alkyl esters thereof.

Furthermore, as the divalent carboxylic acid component, maleic acid, fumaric acid, terephthalic acid or a succinic acid substituted with an alkenyl group with a carbon number of from 2 to 20 can be selected.

Examples of the trivalent or higher valent carboxylic acid component include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1, 3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, enpole trimer acid, and acid anhydrides or lower alkyl esters thereof.

Furthermore, as the trivalent or higher valent carboxylic acid component, 1,2,4-benzenetricarboxylic acid (trimellitic acid) or an acid anhydride or alkyl (carbon number: from 1 to 12) ester thereof can be selected.

In the exemplary embodiment, these divalent carboxylic acids, etc. and trivalent or higher valent carboxylic acids, etc. can be used singly or in combination. In particular, fumaric acid, terephthalic acid or a succinic acid substituted with an alkenyl group with a carbon number of from 2 to 20, all of which are a divalent carboxylic acid component; 1,2,4-benzenetricarboxylic acid (trimellitic acid) which is a trivalent or higher valent carboxylic acid component;

or an acid anhydride or alkyl (carbon number: from 1 to 12) ester thereof can be used as the major component.

In polymerizing the raw material monomers of the polyester, in order to accelerate the reaction, a usually used catalyst such as dibutyltin oxide, a titanium compound, an dialkoxytin(II), tin(II) oxide, a fatty acid tin(II), dioctanoic acid tin(II) and distearic acid tin(II) may be properly used.

Examples of the wax which is used in the exemplary embodiment include ester waxes synthesized from a long-chain alkyl carboxylic acid component and a long-chain alkyl alcohol component. An addition amount of the ester wax can be, for example, set to be from 3 to 17 parts by weight based on 100 parts by weight of the binder resin.

Examples of the acid component of the crystalline polyester resin which is used in the exemplary embodiment include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, n-dodecylsuccinic acid, n-dodecenylsuccinic acid, cyclohexanedicarboxylic acid, trimellitic acid, pyromellitic acid, and acid anhydrides or alkyl (carbon number: from 1 to 3) esters thereof. Furthermore, as the acid component of the crystalline polyester resin which is used in the exemplary embodiment, fumaric acid can be selected.

Examples of the alcohol component of the crystalline polyester resin which is used in the exemplary embodiment include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol and trimethylolpropane. Furthermore, as the alcohol component of the crystalline polyester resin which is used in the exemplary embodiment, 1,4-butanediol or 1,6-hexanediol can be selected.

An addition amount of the crystalline polyester resin can be set to be from 3 to 35 parts by weight based on 100 parts by weight of the binder resin.

In the present exemplary embodiment, a polyester resin having a ratio of softening point to melting temperature ((softening point)/(melting temperature)) of from 0.9 to 1.1 is defined as the crystalline polyester resin.

As the coloring material which is used in the exemplary embodiment, carbon blacks or organic or inorganic pigments or dyes, which are used for color toner applications, can be used. In the exemplary embodiment, though the coloring material is not particularly restricted, for example, acetylene black, furnace black, thermal black, channel black, ketjen black, etc. can be used as the carbon black. Also, for example, Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green, quinacridone, etc. can be used as the pigment or dye. These coloring materials can be used singly or in admixture. Also, though an addition amount of the coloring material is not particularly restricted, it is preferably from 4 to 15 parts by weight based on 100 parts by weight of the binder resin.

As the charge control agent, a metal-containing azo compound is useful, and complexes or complex salts in which a metal element thereof is iron, cobalt or chromium, or mixtures thereof can be used. Also, a metal-containing salicylic acid derivative compound or a metal oxide hydrophobilized material can also be used, and complexes or complex salts in which a metal element thereof is zirconium, zinc, chromium or boron, or mixtures thereof can be used. Furthermore, a clathrate compound of a polysaccharide containing aluminum and magnesium as metal elements can be selected. Though an addition amount of the charge control agent is not particularly restricted, it is preferably from 0.5 to 3 parts by weight based on 100 parts by weight of the binder resin.

The developing agent according to the exemplary embodiment includes a toner which can be, for example, fabricated by adopting a pulverization process.

In the pulverization process, for example, raw materials including a coloring material, a binder resin, an ester wax and a crystalline polyester are mixed and dispersed, and the dispersion is then melt kneaded. After the kneaded material is dried, coarsely pulverized and finely pulverized, the resulting pulverized material is classified to obtain a toner particle. The obtained toner particle can be used as a toner singly or by adding an additive onto the toner particle surface, if desired. Also, the obtained toner can be used as a developing agent singly or mixing a carrier therewith, if desired.

Furthermore, the toner particle can be fabricated by the following manufacturing method.

This method includes a step of first mixing a coarsely granulated mixture containing at least a binder resin and a coloring material with an aqueous medium to prepare a mixed solution; a step of giving a mechanical shear to the mixed solution and finely granulating the coarsely granulated mixture to form a fine particle; a step of aggregating the fine particle to form an aggregated particle; and a step of optionally fusing the aggregated particle to obtain a toner particle.

As to a measure for mixing and dispersing the raw materials, examples of a mixing machine include a Henschel mixer (manufactured by Mitsui Mining Co., Ltd.); a super mixer (manufactured by Kawata Mfg., Co., Ltd.); Ribocone (manufactured by Okawara Mfg., Co., Ltd.); a nauta mixer, a turbulizer and a cyclomixer (all of which are manufactured by Hosokawa Micron Corporation); a spiral pin mixer (manufactured by Pacific Machinery & Engineering Co., Ltd.); and a Loedige mixer (manufactured by Matsubo Corporation). Examples of a kneading machine include a KRC kneader (manufactured by Kurimoto, Ltd.); a Buss Ko-Kneader (manufactured by Buss AG); a TEM type extruder (manufactured by Toshiba Machine Co., Ltd.); a TEX twin-screw kneading machine (manufactured by The Japan Steel Works, Ltd.); a PCM kneading machine (manufactured by Ikegai, Ltd.); a three-roll mill, a mixing roll mill and a kneader (all of which are manufactured by Inoue Mfg., Inc.); Kneadex (manufactured by Mitsui Mining Co., Ltd.); an MS type pressure kneader, a kneader-ruder (manufactured by Moriyama Company Ltd.); and a Banbury mixer (manufactured by manufactured by Kobe Steel, Ltd.).

Also, as to a measure for coarsely pulverizing the mixture, for example, a hammer mill, a cutter mill, a jet mill, a roller mill, a ball mill, etc. can be used. Also, examples of a pulverizer as a measure for finely pulverizing the coarsely pulverized material include a counterjet mill, Micronjet and Inomizer (all of which are manufactured by Hosokawa Micron Corporation); an IDS type mill and a PJM jet pulverizer (all of which are manufactured by Nippon Pneumatic Mfg. Co., Ltd.); Crossjet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); and Turbo Mill (manufactured by Turbo Kogyo Co., Ltd.).

Also, examples of a classifier for classifying the finely pulverized material include Classiel, Micron Classifier and Spedic Classifier (all of which are manufactured by Seisin Enterprises Co., Ltd.); Turbo Classifier (manufactured by Nisshin Engineering Co., Ltd.); Micron Separator, Turboplex (ATP) and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.).

In the exemplary embodiment, respect to the surface of the toner particle obtained through the above-described steps, for the purpose of stabilizing fluidity, charge properties or storage characteristics of the toner, for example, an additive made of an inorganic fine particle, etc. can be mixed. As such an additive, a mixture of at least two kinds of inorganic oxide fine particles having a different particle size from each other, such as silica, titania, alumina, strontium titanate and tin oxide, can be used. From the viewpoint of an enhancement of environmental stability, an inorganic oxide fine particle oxide obtained through a surface treatment with a hydrophobic agent can be used. The inorganic fine particle can, for example, have a size of from 0.01 to 0.3 μm.

Also, in addition to such an inorganic oxide fine particle, for example, a resin fine particle of not more than 1 μm, such as a polysiloxane resin, can be used as the additive.

In order to add the additive onto the toner particle surface, the above-described mixing machines can be used.

Examples of a screening apparatus for classifying coarse particles or the like include Ultra Sonic (manufactured by Koei Sangyo Co., Ltd.); Resona Sieve and Gyroshifter (all of which manufactured by Tokuju Corporation); Vibrasonic System (manufactured by Dalton Co., Ltd.); Soniclean (manufactured by Shinto Kogyo Kabushiki Kaisha); Turboscreener (manufactured by Turbo Kogyo Co., Ltd.); Microshifter (manufactured by Makino Mfg. Co., Ltd.); and a circular vibrating sieve.

FIGURE illustrates a diagrammatic view showing an example of an image forming apparatus to which the developing agent according to the exemplary embodiment is applicable.

As shown in FIGURE, a scanner section 2 and a paper discharge section 3 are provided in an upper portion of a color copier, MFP (e-studio 4520c) 1 of a quadruple tandem system.

The color copier 1 has image forming stations 11Y, 11M, 11C and 11K of four groups of yellow (Y), magenta (M), cyan (C) and black (K) disposed in parallel along a lower side of an intermediate transfer belt (intermediate transfer medium) 10.

The respective image forming stations 11Y, 11M, 11C and 11K have photoreceptor drums (image carriers) 12Y, 12M, 12C and 12K, respectively. In the surroundings of the photoreceptor drums 12Y, 12M, 12C and 12K, electrification chargers 13Y, 13M, 13C and 13K; development apparatuses 14Y, 14M, 14C and 14K; and photoreceptor cleaning apparatuses 16Y, 16M, 16C and 16K are disposed along the rotation direction shown by an arrow S direction. On the way from the electrification chargers 13Y, 13M, 13C and 13K to the development apparatuses 14Y, 14M, 14C and 14K in the surroundings of the photoreceptor drums 12Y, 12M, 12C and 12K, exposure light by a laser exposure apparatus (latent image forming apparatus) 17 is irradiated, an electrostatic latent image is formed on the photoreceptor drums 12Y, 12M, 12C and 12K.

Each of the development apparatuses 14Y, 14M, 14C and 14K has a two-component developing agent made of each of yellow (Y), magenta (M), cyan (C) and black (K) toners and a carrier, respectively and feeds the toner to the electrostatic latent image on the photoreceptor drums 12Y, 12M, 12C and 12K, respectively.

The intermediate transfer belt 10 is hung by a backup roller 21, a driven roller 20 and first to third tension rollers 22 to 24. The intermediate transfer belt 10 is opposed to and brought into contact with the photoreceptor drums 12Y, 12M, 12C and 12K. Primary transfer rollers 18Y, 18M, 18C and 18K for primarily transferring the toner images on the photoreceptor drums 12Y, 12M, 12C and 12K onto the intermediate transfer belt 10 are provided at positions of the intermediate transfer belt 10 opposing to the photoreceptor drums 12Y, 12M, 12C and 12K, respectively. Each of these primary transfer rollers 18Y, 18M, 18C and 18K is a conductive roller, and a primary transfer bias voltage is impressed in each of these primary transfer sections.

A secondary roller 27 is disposed in a secondary transfer section which is a transfer position of the intermediate transfer belt 10 supported by the backup roller 21. In the secondary transfer section, the backup roller 21 is a conductive roller, and a prescribed secondary transfer bias is impressed thereto. When a sheet paper (final transfer medium) that is an object to printing passes between the intermediate transfer belt 10 and the secondary transfer roller 27, the toner image on the intermediate transfer belt 10 is secondarily transferred onto the sheet paper. After completion of the secondary transfer, the intermediate transfer belt 10 is cleaned up by a belt cleaner 10a.

A paper feed cassette 4 for feeding a sheet paper P1 toward the direction of the secondary transfer roller 27 is provided in a lower portion of the laser exposure apparatus 17. A manual-bypass mechanism 31 for manually feeding a sheet paper P2 is provided on the right side of the color copier 1.

On the way from the paper feed cassette 4 to the secondary transfer roller 27, a pickup roller 4a, a separation roller 28a, a carrying roller 28b and a resist roller pair 36 are provided, thereby constituting a paper feed mechanism. On the way from a manual-bypass tray 31a of the manual-bypass mechanism 31 to the resist roller pair 36, a manual-bypass pickup roller 31b and a manual-bypass separation roller 31c are provided.

Furthermore, a medium sensor 39 for detecting the kind of sheet paper is disposed on a vertical carrying route 35 for carrying the sheet paper from the paper feed cassette 4 or the manual-bypass tray 31a toward the direction of the secondary transfer roller 27. The color copier 1 is able to control a carrying rate of sheet paper, a transfer condition, a fixing condition and so on from the detection results by the medium sensor 39. Also, a fixing apparatus 30 is provided in the downstream of the secondary transfer section along the direction of the vertical carrying route 35.

The sheet paper taken out from the paper feed cassette 4 or fed from the manual-bypass mechanism 31 is carried into the fixing apparatus 30 through the resist roller pair 36 and the secondary transfer roller 27 along the vertical carrying route 35. The fixing apparatus 30 has a fixing belt 53 wound around a pair of a heating roller 51 and a driving roller 52 and a counter roller 54 disposed opposing to the heating roller 51 via the fixing belt 53. The sheet paper having a toner image transferred in the secondary transfer section is introduced between the fixing belt 53 and the counter roller 54, and the toner image transferred onto the sheet paper is heat treated and fixed upon heating by the heating roller 51. A gate 33 is provided in the downstream of the fixing apparatus 30, whereby the sheet paper is distributed into the direction of a paper discharge roller 41 or the direction of a recarrying unit 32. The sheet paper introduced into the paper discharge roller 41 is discharged into the paper discharge section 3. Also, the sheet paper introduced into the recarrying unit 32 is again introduced onto the direction of the secondary transfer roller 27.

The image forming station 11Y has the photoreceptor drum 12Y and a process measure in an integral manner and is provided in a detachable manner relative to a main body of the image forming apparatus. The process measure as referred to herein means at least one of the electrification charger 13Y, the development apparatus 14Y and the photoreceptor cleaning apparatus 16Y. Each of the image forming stations 11M, 11C and 11K has the same configuration as the image forming station 11Y. Each of the image forming stations 11Y, 11M, 11C and 11K may be detachable relative to the image forming apparatus or may be detachable as the integrated image forming unit 11 relative to the image forming apparatus.

Hereinafter, exemplary embodiments will be more specifically described by reference to the following Examples.

Also, various evaluation methods used in the Examples are shown below.

### [Preparation Examples of Ester Waxes]

### Preparation of Ester Waxes (A), (B) and (C)

In a four-necked flask equipped with a stirrer, a thermocouple and a nitrogen-introducing pipe, 80 parts by weight of a long-chain alkyl carboxylic acid component and 20 parts by weight of a long-chain alkyl alcohol component were charged and subjected to an esterification reaction at 220° C. in a nitrogen gas stream. The obtained reaction product was diluted with a mixed solvent of toluene and ethanol, to which was then added a sodium hydroxide aqueous solution, and the mixture was stirred at 70° C. for 30 minutes. Thereafter, the reaction mixture was allowed to stand for 30 minutes, thereby removing an aqueous layer part. Furthermore, an operation of adding ion-exchanged water, stirring the mixture at 70° C. for 30 minutes and then allowing the reaction mixture to stand for 30 minutes, thereby removing an aqueous layer part was repeated five times. The solvent was distilled off from the obtained ester layer under a reduced pressure condition, thereby obtaining Ester Wax (A) having an acid value of 0.1 mgKOH/g and a hydroxyl value of 0.5 mgKOH/g. A structural formula of the ester wax is expressed by the following formula (1).

CH₃(CH₂)ₙCOO(CH₂)ₘCH₃ (1)

In the formula (1), each of n and m represents a constant.

Also, Ester Wax (B) and Ester Wax (C) were prepared by changing the kind and amount of the long-chain alkyl carboxylic acid and the kind and amount of the long-chain alkyl alcohol. In particular, in the case of broadening the distribution, the adjustment was carried out by using plural kinds as to both of the long-chain alkyl carboxylic acid component and the long-chain alkyl alcohol component.

Data of each of Ester Waxes (A), (B) and (C) is shown in Table 1.

TABLE 1

| | | | | | | | | | | Melting | | Hydroxyl |
|---|---|---|---|---|---|---|---|---|---|---|---|---|
| | Content proportion of ester compound (% by weight) | | | | | | | | | point | Acid value | value |
| Wax | C32 | C34 | C36 | C38 | C40 | C42 | C44 | C46 | C48 | (° C.) | (mgKOH/g) | (mgKOH/g) |
| A | 0 | 0 | 2.3 | 3.1 | 13.8 | 27 | 44.7 | 3.7 | 5.4 | 68 | 0.1 | 0.5 |
| B | 0 | 0 | 0 | 2.5 | 18.5 | 15.4 | 55 | 8.6 | 0 | 74 | 0.1 | 0.4 |
| C | 0 | 0 | 6 | 3.2 | 22.4 | 22.1 | 22 | 18.9 | 5.4 | 61 | 0.1 | 0.4 |

### Long-Chain Alkyl Carboxylic Acid Component

Palmitic acid (C₁₆H₃₂O₂)

Stearic acid (C₁₈O₃₆O₂)

Arachidic acid (C₂₀H₄₀O₂)

Behenic acid (C₂₂H₄₄O₂)

Lignoceric acid (C₂₄H₄₈O₂)

### Long-Chain Alkyl Alcohol Component

Palmityl alcohol (C₁₆H₃₄O)

Stearyl alcohol (C₁₈H₃₈O)

Arachidic alcohol (C₂₀H₄₂O)

Behenyl alcohol (C₂₂H₄₆O)

Lignoceryl alcohol (C₂₄H₄₈O)

Also, the melting point of the obtained ester wax was measured using a differential scanning calorimeter (DSC Q2000, manufactured by TA Instruments). The measurement is carried out under the following condition.

Sample: 5 mg

Lid and pan: Made of alumina

Temperature elevation rate: 10° C./min

Measurement temperature: 20 to 200° C.

Data obtained by the measurement when the sample heated to 200° C. is cooled to not higher than 20° C. and again heated is employed, and a maximum endothermic peak generated at from around 60° C. to around 80° C. is defined as a melting point of the wax. Also, a maximum endothermic peak generated at from around 80° C. to around 120° C. is defined as a melting point of the crystalline polyester resin.

For a mass analysis of the obtained ester wax, FD/MS (JMS-T100GC, manufactured by JEOL Ltd.) was used. 1 mg of a sample (dissolved in 1 mL of chloroform) was used. Under conditions at a cathode voltage of −10 kV and at a spectrum recording interval of 0.4 seconds in the measuring mass range m/z of from 10 to 2,000, all of intensities of the respective carbon numbers of the ester compounds were gathered to 100, and a relative intensity of each carbon number was calculated, thereby confirming a maximum intensity.

Incidentally, as to Ester Wax (H) using rice wax, C54 was defined as the maximum intensity.

The acid value and hydroxyl value of the obtained ester wax were measured in conformity with JIS K0070.

### Preparation of Comparative Ester Wax (D)

The blending amounts of behenic acid and behenyl alcohol were increased, thereby preparing Comparative Ester Wax (D) in which the ester compound with a carbon number as a maximum frequency among the carbon numbers of from C32 to C46 occupied 60% or more of the whole of the wax. Data of Comparative Ester Wax (D) is shown in Table 2.

### Preparation of Comparative Ester Wax (E)

The blending amounts of stearic acid and stearyl alcohol were increased, thereby preparing Comparative Ester Wax (E) in which the ester compounds with a carbon number of not more than 38 occupied 10% or more of the whole of the wax. Data of Comparative Ester Wax (E) is shown in Table 2.

### Preparation of Comparative Ester Wax (F)

The blending amounts of stearic acid and stearyl alcohol were increased, thereby preparing Comparative Ester Wax (F) in which the ester compound with a carbon number of 40 occupied less than 20% of the whole of the wax. Data of Comparative Ester Wax (F) is shown in Table 2.

### Preparation of Comparative Ester Wax (G)

Comparative Ester Was (G) was prepared using only palmitic acid as the acid component and palmityl alcohol as the alcohol component. Data of Comparative Ester Wax (G) is shown in Table 2.

### Comparative Ester Wax (H)

Rice wax is used. Data is shown in Table 3.

TABLE 2

| | | | | | | | | | | Melting | | Hydroxyl |
|---|---|---|---|---|---|---|---|---|---|---|---|---|
| | Content proportion of ester compound (% by weight) | | | | | | | | | point | Acid value | value |
| Wax | C32 | C34 | C36 | C38 | C40 | C42 | C44 | C46 | C48 | (° C.) | (mgKOH/g) | (mgKOH/g) |
| D | 0 | 0 | 0 | 0.5 | 6.2 | 16.4 | 73 | 1 | 2.9 | 76 | 0.1 | 0.5 |
| E | 0 | 0 | 5.3 | 6.8 | 13.8 | 27 | 40 | 2.7 | 4.4 | 65 | 0.1 | 0.5 |
| F | 0 | 5.4 | 14.7 | 13.9 | 18.7 | 9.5 | 17.8 | 13.6 | 6.4 | 63 | 0.1 | 0.3 |
| G | 100 | 0 | 0 | 0 | 0 | 0 | 0 | 0 | 0 | 59 | 0.1 | 0.4 |

TABLE 3

| | | | | | | | | | | Melting | | Hydroxyl |
|---|---|---|---|---|---|---|---|---|---|---|---|---|
| | Content proportion of ester compound (% by weight) | | | | | | | | | point | Acid value | value |
| Wax | C46 | C48 | C50 | C52 | C54 | C56 | C58 | C60 | C62 | (° C.) | (mgKOH/g) | (mgKOH/g) |
| H | 7 | 12 | 13 | 18 | 20 | 15 | 10 | 5 | 0 | 79 | 6.3 | 15.4 |

### Evaluation of Fixing Offset

By modifying a fixing system of a commercially available copier, the fixing temperature is set up at 130° C., and 10 sheets of a solid image are acquired. In those ten sheets, the case where the image separation due to offset or unfixing did not occur even slightly is defined as “Good”; and the case where the image separation occurred is defined as “Bad”.

### Life Extension (Toner Scattering)

By using a commercially available copier, an original with a printing ratio of 8.0% was continuously copied on 300,000 sheets of A4. At that time, the case where staining such as falling of toner, etc. to be caused due to the toner scattering was not confirmed is defined as “Good”; and the case where staining was confirmed is defined as “Bad”.

### Storage Characteristic

15 g of a toner is hermetically sealed in a plastic vessel and allowed to stand in a thermostat set up at 45° C. for 200 hours. After taking out from the thermostat, the toner was allowed to stand for naturally cooling for 12 hours or more. By using a powder tester (manufactured by Hosokawa Micron Corporation), the obtained toner was placed on a screen having an opening of 42 mesh and vibrated for 10 seconds at a dial of 4. The case where the amount of the toner remaining on the screen after the vibration was less than 3 g is defined as “Good”; and the case where the amount of the toner remaining on the screen after the vibration was 3 g or more is defined as “Bad”.

### EXAMPLE 1

Polyester resin (binder): 80 parts by weight

Crystalline polyester resin: 10 parts by weight

Ester Wax (A): 3 parts by weight

Coloring material (MA-100): 6 parts by weight

Charge control agent (polysaccharide compound containing Al and Mg): 1 part by weight

The foregoing materials were mixed in a Henschel mixer, and the mixture was melt kneaded by a twin-screw extruder. The obtained melt kneaded material was cooled and then coarsely pulverized by a hammer mill. Subsequently, the coarsely pulverized material was finely pulverized by a jet pulverizer and classified, thereby obtaining a powder having a volume average particle size of 7 μm and a toner Tg of 38.9° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner.

The obtained toner was stirred in a proportion of 6 parts by weight based on 100 parts by weight of a silicone resin-surface coated ferrite carrier having an average particle size of 40 μm in a tabular mixer, thereby obtaining a developing agent.

The obtained toner and developing agent were set in a full color copier which was modified so as to freely adjust a fixing temperature, the fixing temperature was set up at 130° C., and 10 sheets of a solid image with a toner deposition amount of 1.6 mg/cm² were allowed to pass therethrough, thereby confirming whether or not offset occurred. As a result, it could be confirmed that the offset did not occur. Furthermore, the above-described quality characteristics of life extension and storage characteristic were confirmed. The evaluation results are summarized in Table 4. Incidentally, the toner Tg was determined by using the following apparatus and measurement condition.

0.5 g of the toner was weighed and charged in an Erlenmeyer flask. In the Erlenmeyer flask, 2 mL of methylene chloride was added, thereby dissolving the toner therein. Furthermore, 4 mL of hexane was added, an insoluble matter was filtered off, and the solvent was distilled off in a nitrogen gas stream. A deposit was subjected to FD/MS measurement similar to the case of a simple material of the wax. The measurement results are summarized in Table 4.

### Toner Tg

The toner Tg is measured by using DSC (DSC Q2000, manufactured by TA Instruments). The measurement is carried out under the following condition.

Sample: 5 mg

Lid and pan: Made of alumina

Temperature elevation rate: 10° C./min

Measurement temperature: 20 to 200° C.

Data obtained by the measurement when the sample heated to 200° C. is cooled to not higher than 20° C. and again heated is employed. Tangents on the low temperature side and the high temperature side of a curve generated at from around 30° C. to around 60° C. are drawn, and a point of intersection of extension lines thereof is defined as Tg.

### EXAMPLE 2

Polyester resin (binder): 84.5 parts by weight

Crystalline polyester resin: 3 parts by weight

Ester Wax (A): 6 parts by weight

Coloring material (MA-100): 6 parts by weight

Charge control agent (polysaccharide compound containing Al and Mg): 0.5 parts by weight

The foregoing materials were treated in the same manner as in Example 1, thereby obtaining a powder having a volume average particle size of 7 μm and a toner Tg of 43.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 3

Polyester resin (binder): 62 parts by weight

Crystalline polyester resin: 20 parts by weight

Ester Wax (A): 10 parts by weight

Coloring material (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm and a toner Tg of 34.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 4

Polyester resin (binder): 73 parts by weight

Crystalline polyester resin: 10 parts by weight

Ester Wax (A): 10 parts by weight

Coloring material (MA-100): 6 parts by weight

Charge control agent (polysaccharide compound containing Al and Mg): 1 part by weight

The foregoing materials were treated in the same manner as in Example 1, thereby obtaining a powder having a volume average particle size of 7 μm and a toner Tg of 35.6° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 5

Polyester resin (binder): 84.5 parts by weight

Crystalline polyester resin: 3 parts by weight

Ester Wax (B): 6 parts by weight

Coloring material (MA-100): 6 parts by weight

Charge control agent (polysaccharide compound containing Al and Mg): 0.5 parts by weight

The foregoing materials were treated in the same manner as in Example 1, thereby obtaining a powder having a volume average particle size of 7 μm and a toner Tg of 43.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 6

Polyester resin (binder): 76 parts by weight

Crystalline polyester resin: 6 parts by weight

Ester Wax (B): 10 parts by weight

Coloring material (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm and a toner Tg of 40.2° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 7

Polyester resin (binder): 87 parts by weight

Crystalline polyester resin: 3 parts by weight

Ester Wax (B): 3 parts by weight

Coloring material (MA-100): 6 parts by weight

Charge control agent (polysaccharide compound containing Al and Mg): 1 part by weight

The foregoing materials were treated in the same manner as in Example 1, thereby obtaining a powder having a volume average particle size of 7 μm and a toner Tg of 45.6° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 8

Polyester resin (binder): 81.5 parts by weight

Crystalline polyester resin: 6 parts by weight

Ester Wax (C): 6 parts by weight

Coloring material (MA-100): 6 parts by weight

Charge control agent (polysaccharide compound containing Al and Mg): 0.5 parts by weight

The foregoing materials were treated in the same manner as in Example 1, thereby obtaining a powder having a volume average particle size of 7 μm and a toner Tg of 41.6° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 9

Polyester resin (binder): 72 parts by weight

Crystalline polyester resin: 10 parts by weight

Ester Wax (C): 10 parts by weight

Coloring material (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm and a toner Tg of 35.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 10

Polyester resin (binder): 75 parts by weight

Crystalline polyester resin: 15 parts by weight

Ester Wax (C): 3 parts by weight

Coloring material (MA-100): 6 parts by weight

Charge control agent (polysaccharide compound containing Al and Mg): 1 part by weight

The foregoing materials were treated in the same manner as in Example 1, thereby obtaining a powder having a volume average particle size of 7 μm and a toner Tg of 35.9° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### EXAMPLE 11

Polyester resin (binder): 63 parts by weight

Crystalline polyester resin: 20 parts by weight

Ester Wax (C): 10 parts by weight

Coloring agent (MA-100): 6 parts by weight

Charge control agent (polysaccharide compound containing Al and Mg): 1 part by weight

The foregoing materials were mixed in a Henschel mixer, and the mixture was melt kneaded by a twin-screw extruder. The obtained melt kneaded material was cooled and coarsely pulverized by a hammer mill. Subsequently, the coarsely pulverized material was further pulverized using a pulverizer, manufactured by Hosokawa Micron Corporation, thereby obtaining an interim pulverized particle having a volume average particle size of 58 μm. 30 parts by weight of the obtained interim pulverized particle, 1 part by weight of sodium dodecylbenzenesulfonate (NEOPELEX G-15) as an anionic surfactant, 1 part by weight of triethylamine as an amine compound and 68 parts by weight of ion-exchanged water were mixed by a homogenizer, manufactured by IKA, thereby obtaining Mixed Solution 1.

Subsequently, the obtained Mixed Solution 1 was charged in NANO-MIZER (YSNM-2000AR, manufactured by Yoshida Kikai Co., Ltd., to which a heating system was add) in which the heating system temperature was set up at 120° C., and treated repeatedly three times under a treatment pressure of 150 MPa. After cooling, a volume average particle size of the obtained colored fine particle was measured by SALD-7000 (manufactured by Shimadzu Corporation), and as a result, it was found to be 0.7 μm. A pH of the fine particle liquid dispersion was 8.2.

Subsequently, the liquid dispersion was diluted such that a solids content of the colored fine particle was 18%, to which was then added dropwise 0.1 M hydrochloric acid, thereby adjusting the pH. The liquid dispersion was controlled to a temperature of 30° C. At a point of time when the pH reached 7.0, the particle size was measured, and as a result, it was found to be 0.85 μm. Furthermore, 0.1 M hydrochloric acid was added dropwise, and at a point of time when a ξ potential of the fine particle reached −30 mV, the dropwise addition was finished. At that time, the pH was 3.9.

Subsequently, the above-described liquid dispersion was subjected to temperature elevation to 80° C. at a rate of 10° C./min while stirring with a paddle blade (at 500 rpm) and then kept at 80° C. for one hour. After cooling, the liquid dispersion was allowed to stand overnight, and the state of a supernatant was observed. As a result, the supernatant was transparent, and any unaggregated particle was not observed. Also, the volume average particle size was measured, and as a result, it was found to be 6 μm, and any coarse particle of 20 μm or more was not observed. Thereafter, the resultant was dried by a vacuum dryer until the water content reached not more than 0.8% by weight, thereby obtaining a powder having a volume average particle size of 6 μm and a toner Tg of 33.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 1

Polyester resin (binder): 76 parts by weight

Crystalline polyester resin: 10 parts by weight

Ester Wax (D): 6 parts by weight

Coloring material (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm and a toner Tg of 40.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 2

Polyester resin (binder): 80 parts by weight

Crystalline polyester resin: 2 parts by weight

Ester Wax (D): 10 parts by weight

Coloring material (MA-100): 6 parts by weight

Charge control agent (metal-containing salicylic acid derivative): 2 parts by weight

The foregoing materials were treated in the same manner as in Example 1, thereby obtaining a powder having a volume average particle size of 7 μm and a toner Tg of 50.5° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 3

Polyester resin (binder): 60 parts by weight

Crystalline polyester resin: 25 parts by weight

Ester Wax (E): 6 parts by weight

Coloring material (MA-100): 6 parts by weight

Charge control agent (polysaccharide compound containing Al and Mg): 3 parts by weight

The foregoing materials were treated in the same manner as in Example 1, thereby obtaining a powder having a volume average particle size of 7 μm and a toner Tg of 30.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 4

Polyester resin (binder): 90.5 parts by weight

Crystalline polyester resin: 0 part by weight

Ester Wax (E): 2 parts by weight

Coloring material (MA-100): 6 parts by weight

Charge control agent (metal-containing salicylic acid derivative): 1.5 parts by weight

The foregoing materials were treated in the same manner as in Example 1, thereby obtaining a powder having a volume average particle size of 7 μm and a toner Tg of 57.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 5

Polyester resin (binder): 66.5 parts by weight

Crystalline polyester resin: 20 parts by weight

Ester Wax (F): 6 parts by weight

Coloring material (MA-100): 6 parts by weight

Charge control agent (polysaccharide compound containing Al and Mg): 1.5 parts by weight

The foregoing materials were treated in the same manner as in Example 1, thereby obtaining a powder having a volume average particle size of 7 μm and a toner Tg of 31.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 6

Polyester resin (binder): 57 parts by weight

Crystalline polyester resin: 20 parts by weight

Ester Wax (G): 15 parts by weight

Coloring material (MA-100): 6 parts by weight

Charge control agent (metal-containing azo compound): 2 parts by weight

The foregoing materials were treated in the same manner as in Example 1, thereby obtaining a powder having a volume average particle size of 7 μm and a toner Tg of 30.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 7

Polyester resin (binder): 76 parts by weight

Crystalline polyester resin: 10 parts by weight

Ester Wax (H): 6 parts by weight

Coloring material (MA-100): 6 parts by weight

Charge control agent (metal-containing azo compound and polysaccharide compound containing Al and Mg): 2 parts by weight

The foregoing materials were treated in the same manner as in Example 1, thereby obtaining a powder having a volume average particle size of 7 μm and a toner Tg of 40.6° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 8

Polyester resin (binder): 82 parts by weight

Crystalline polyester resin: 0 parts by weight

Ester Wax (H): 10 parts by weight

Coloring material (MA-100): 6 parts by weight

Charge control agent (metal-containing salicylic acid derivative and polysaccharide compound containing Al and Mg): 2 parts by weight

The foregoing materials were treated in the same manner as in Example 1, thereby obtaining a powder having a volume average particle size of 7 μm and a toner Tg of 54.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 9

Polyester resin (binder): 82 parts by weight

Crystalline polyester resin: 0 parts by weight

Ester Wax (A): 10 parts by weight

Coloring material (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm and a toner Tg of 38.5° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

### COMPARATIVE EXAMPLE 10

Polyester resin (binder): 69 parts by weight

Crystalline polyester resin: 20 parts by weight

Ester Wax (B): 3 parts by weight

Coloring material (MA-100): 6 parts by weight

Charge control agent (polysaccharide compound containing Al and Mg): 2 parts by weight

The foregoing materials were treated in the same manner as in Example 1, thereby obtaining a powder having a volume average particle size of 7 μm and a toner Tg of 32.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are also shown in Table 4.

TABLE 4

| | | Ester wax extracted from toner | | | | | | | | |
|---|---|---|---|---|---|---|---|---|---|---|
| | | Carbon number | | Proportion | | | | | | |
| | | and proportion | | of carbon | | | | | | |
| | | (%) showing | | number | | | | | | Melting |
| | | maximum intensity | | of not | Low- | | | | Melting | point of |
| | | Carbon | Proportion | more than | temperature | Life extension | | Toner | point | crystalline |
| | Used wax | number | (%) | C38 (%) | fixation | (toner scattering) | Preservability | Tg | of wax (° C.) | polyester (° C.) |
| Example 1 | A | C44 | 44.9 | 5.4 | Good | Good | Good | 38.9 | 68 | 92 |
| Example 2 | A | C44 | 44.3 | 5.6 | Good | Good | Good | 43.4 | 68 | 100 |
| Example 3 | A | C44 | 44.5 | 5.7 | Good | Good | Good | 34.1 | 68 | 110 |
| Example 4 | A | C44 | 44.8 | 5.4 | Good | Good | Good | 35.6 | 68 | 92 |
| Example 5 | B | C44 | 54.6 | 2.6 | Good | Good | Good | 43.1 | 74 | 92 |
| Example 6 | B | C44 | 54.8 | 2.8 | Good | Good | Good | 40.2 | 74 | 100 |
| Example 7 | B | C44 | 54.5 | 2.5 | Good | Good | Good | 45.6 | 74 | 110 |
| Example 8 | C | C40 | 22 | 9.6 | Good | Good | Good | 41.6 | 61 | 92 |
| Example 9 | C | C40 | 22.6 | 9.8 | Good | Good | Good | 35.4 | 61 | 100 |
| Example 10 | C | C40 | 22.3 | 8.9 | Good | Good | Good | 35.9 | 61 | 110 |
| Example 11 | C | C40 | 22.8 | 8.6 | Good | Good | Good | 33.4 | 61 | 92 |
| Comparative | D | C44 | 72.6 | 1 | Good | Bad | Good | 40.1 | 76 | 87 |
| Example 1 | | | | | | | | | | |
| Comparative | D | C44 | 73.4 | 1.6 | Bad | Good | Good | 50.5 | 76 | 100 |
| Example 2 | | | | | | | | | | |
| Comparative | E | C44 | 39.4 | 12.6 | Good | Bad | Bad | 30.4 | 65 | 115 |
| Example 3 | | | | | | | | | | |
| Comparative | E | C44 | 40.6 | 12.4 | Bad | Good | Good | 57.4 | 65 | Not added |
| Example 4 | | | | | | | | | | |
| Comparative | F | C40 | 19.1 | 21.6 | Good | Bad | Bad | 31.1 | 63 | 92 |
| Example 5 | | | | | | | | | | |
| Comparative | G | C32 | 99.7 | 100.0 | Good | Bad | Bad | 30.1 | 58 | 115 |
| Example 6 | | | | | | | | | | |
| Comparative | H | C54 | 18.6 | 0 | Good | Bad | Good | 40.6 | 79 | 92 |
| Example 7 | | | | | | | | | | |
| Comparative | H | C54 | 19.4 | 0 | Bad | Good | Good | 54.1 | 79 | Not added |
| Example 8 | | | | | | | | | | |
| Comparative | A | C44 | 44.3 | 5.7 | Good | Good | Bad | 38.5 | 68 | Not added |
| Example 9 | | | | | | | | | | |
| Comparative | B | C44 | 54.1 | 2.5 | Good | Bad | Bad | 32.4 | 74 | 87 |
| Example 10 | | | | | | | | | | |

Low-temperature fixation and Tg lowering of the toner are correlated with each other. There are two kinds of methods of lowering Tg of the toner, a method in which Tg of the resin is decreased, thereby achieving Tg lowering of the toner and a method in which a wax or crystalline polyester resin with good dispersibility is added, thereby achieving Tg lowering of the toner. However, the low-temperature fixation and the preservability are in a trade-off relation, and when the toner is subjected to Tg lowering, the preservability is deteriorated. Thus, it may be difficult to satisfy the both characteristics. On the other hand, according to these exemplary embodiments or working examples, it was noted that by using an ester wax in which the amount of ester compounds having a short straight-chain alkyl group with a carbon number of not more than 38 is small and a crystalline polyester resin to achieve Tg lowering of the toner, rather than undergoing Tg lowering of the resin, the low-temperature fixation is excellent. In this way, according to the exemplary embodiments, a developing agent in which three characteristics of low-temperature fixation, preservability and life extension are favorable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent comprising a toner particle containing a coloring material, a binder resin, an ester wax having an alkyl group with a carbon number of from 32 to 46, and a crystalline polyester resin having an endothermic peak, as measured by a differential scanning colorimeter, of from 90 to 110° C., wherein
in the ester wax, when an ion intensity ratio at each carbon number of the ester wax is expressed in terms of percentage, a content of an ester compound having a carbon number showing its maximum intensity ratio is from 20 to 55% by weight of the whole of the wax;
a content of ester compounds with a carbon number of not more than 38 is not more than 10% by weight of the whole of the wax; and
an endothermic peak, as measured by the differential scanning colorimeter, is from 60 to 75° C.

2. The developing agent according to claim 1, wherein an addition amount of the crystalline polyester is from 3 to 35 parts by weight based on 100 parts by weight of the binder resin.

3. The developing agent according to claim 1, wherein an addition amount of the ester wax is from 3 to 17 parts by weight based on 100 parts by weight of the binder resin.

4. The developing agent according to claim 1, wherein the ester wax is obtained by performing an esterification reaction using a carboxylic acid component with a carbon number of from 16 to 24 and an alcohol component with a carbon number of from 16 to 22.

5. The developing agent according to claim 1, wherein an additive made of an inorganic oxide particle is further added onto the toner particle surface.
